(19) United States
(12) Patent Application Publication
(10) Pub. No.: US 2026/0109538 A1
(43) Pub. Date: Apr. 23, 2026

(54) REFUSE CONTAINER

(71) Applicants: Christine Mancusi, New York, NY (US); Michael Mancusi, Staten Island, NY (US)

(72) Inventors: Christine Mancusi, New York, NY (US); Michael Mancusi, Staten Island, NY (US)

(21) Appl. No.: 18/820,141

(22) Filed: Oct. 21, 2024

(51) Int. Cl. B65F 1/06; B65F 1/16

(52) U.S. Cl. CPC B65F 1/068; B65F 1/065; B65F 1/163; B65F 2001/1676

(57) ABSTRACT

Embodiments of the disclosed technology are directed to devices, systems and/or apparatuses directed to a refuse receptacle specially adapted to facilitate the quick and effortless unloading of full trash bags and placement of new, empty trash bags therein. Specifically, the disclosed technology may have at least a receptacle body formed of one or more side wall portions. The body has a base and a top lid as well as a mechanism for toggling of the lid for purposes of placing refuse into the receptacle and/or a bag disposed therein. Furthermore, in each embodiment, the side walls have one or more doors hingedly affixed at at least one edge in order to facilitate the opening of the door or doors in order to access the interior region of the receptacle.

### FIELD OF THE INVENTION

The present invention relates to waste management, particularly to waste container solutions adapted for effortless bag replacement.

### BACKGROUND OF THE INVENTION

Garbage pails, a ubiquitous fixture in our daily lives, have undergone significant technological advancements in recent years. This evolution has been driven by a combination of factors, including increased environmental awareness, advancements in materials science, and the desire for more efficient and convenient waste management solutions. This overview will delve into the various types of garbage pails currently available on the market, focusing on their construction, features, and applications.

While the concept of a dedicated container for waste may seem relatively recent, its roots can be traced back to ancient civilizations. The Romans, renowned for their engineering prowess and urban planning, implemented a rudimentary waste management system. They designated specific areas within the city for garbage disposal, often near bodies of water or in low-lying areas. These areas were typically open pits or trenches where waste was simply dumped.

During the Middle Ages, European cities faced significant challenges in managing waste. The rapid growth of urban centers, coupled with poor sanitation practices, created ideal conditions for the spread of diseases. The Black Death, a devastating pandemic that swept across Europe in the 14th century, highlighted the urgent need for improved waste disposal. To mitigate the risk of contagion, cities began to implement regulations governing the collection and disposal of refuse. This often involved the appointment of “raking men” or “scavengers” who were responsible for clearing the streets of garbage and transporting it to designated dumping grounds.

The Industrial Revolution brought about a dramatic transformation in society, including the rapid growth of cities. As populations swelled, the problem of waste management became increasingly acute. The increased production of goods and the associated waste generated by factories and households overwhelmed existing disposal methods. To address this challenge, cities began to experiment with new technologies and infrastructure. In the 19th century, the development of centralized sewer systems and the invention of the garbage can played a crucial role in improving sanitation and public health.

The modern garbage can emerged as a practical solution to the growing waste problem. Early versions were often made of wood or metal and were typically placed outside homes or businesses. These cans were emptied on a regular basis by municipal workers who would collect the waste and transport it to landfills or incinerators. As technology advanced, the design and materials used for garbage cans evolved. The introduction of plastic in the 20th century led to the development of lightweight, durable, and often colorful containers.

The 20th century witnessed significant advancements in waste management practices. The development of recycling programs and the increasing emphasis on sustainability have led to a shift in attitudes towards waste disposal. Today, garbage cans are often equipped with features such as recycling compartments, odor control mechanisms, and even smart technology that can track waste levels and optimize collection schedules.

Currently available waste pails have undergone significant technological advancements in recent years. This evolution has been driven by a combination of factors, including increased environmental awareness, advancements in materials science, and the desire for more efficient and convenient waste management solutions. This overview will delve into the various types of garbage pails currently available on the market, focusing on their construction, features, and applications.

Traditional metal and plastic garbage pails, while still widely used, have been joined by specialized options catering to specific needs. Recycling pails, with multiple compartments for separating different materials, are essential for promoting sustainable waste management. Compost pails, designed to collect organic waste for composting, contribute to reducing landfill waste and enriching soil. Medical waste pails, equipped with puncture-resistant liners and biohazard labels, ensure the safe disposal of hazardous materials. For outdoor use, durable pails made of metal or heavy-duty plastic provide weather resistance and protection against pests.

The integration of technology into garbage pails has further elevated their capabilities. Sensor-based pails, equipped with sensors to detect when they are full, can optimize waste collection routes and reduce unnecessary pickups. IoT-enabled (“internet-of-things”) pails, connected to the internet, offer real-time data on waste levels, fill rates, and other relevant information, facilitating more efficient and sustainable waste management practices.

Beyond these specialized features, modern garbage pails often incorporate additional enhancements. Odor control mechanisms, such as activated carbon filters or odor-neutralizing agents, help to mitigate unpleasant smells. Lid designs vary widely, from simple hinged lids to automatic opening and closing mechanisms, offering convenience and safety. Wheels on larger pails facilitate easy mobility, while built-in recycling compartments or compatibility with recycling bins promote efficient waste separation.

The efficient and effective collection of trash is a fundamental service provided by municipalities worldwide. However, the specific solutions employed can vary widely depending on factors such as population density, geographical location, economic conditions, and cultural norms. This essay will explore some of the common trash pickup solutions implemented in different cities around the globe.

Perhaps the most familiar method of trash pickup is the curbside collection system. In this approach, residents place their trash and recycling bins at the curb on designated days for collection by municipal workers. This system is widely used in many cities, particularly those with a relatively low population density. However, it can be less efficient in densely populated areas, where narrow streets and limited parking space can make collection difficult.

In some cities, particularly those with high-rise buildings or limited space for above-ground waste storage, underground waste collection systems are used. These systems involve a network of underground pipes or containers that connect to individual buildings. Trash is deposited into chutes or collection points within the buildings, and then transported underground to a central location for collection. While underground systems can be more efficient and aesthetically pleasing, they can be expensive to install and maintain.

In certain areas, particularly in rural or remote regions, centralized waste collection systems may be employed. These systems involve the establishment of designated drop-off points or transfer stations where residents can bring their trash for collection. This approach can be effective in areas with low population density or limited road infrastructure, but it can also require residents to travel longer distances to dispose of their waste.

In some cities, private waste management companies may be contracted to provide trash pickup services. This can offer flexibility and competition, potentially leading to lower costs and improved service quality. However, it can also create challenges in terms of coordination and regulation. Technological Innovations In recent years, technological advancements have led to the development of innovative trash pickup solutions. For example, some cities have implemented smart waste management systems that use sensors to monitor waste levels in bins and optimize collection routes. Additionally, the use of autonomous vehicles for trash collection is being explored in some areas.

The choice of trash pickup solution for a particular city depends on a variety of factors, including the size and density of the population, the availability of infrastructure, and the specific needs and preferences of residents. By carefully considering these factors, municipalities can select the most appropriate and effective approach to waste management.

Regardless of which trash implementation is used, consumers have generally stuck with traditional lidded garbage pails inside their homes and for trash disposal. Removing a plastic trash bag from a garbage container can be a frustrating task due to the vacuum seal that forms between the bag and the container, especially when the bag is full and heavy. This vacuum effect, combined with the friction between the bag and the container, makes it difficult to lift the bag without also lifting the entire container. Moreover, this oftentimes results in the garbage bag ripping as it is removed from the container. This problem is particularly challenging for the elderly or physically impaired, who may struggle with the combined weight and resistance. Furthermore, the flimsy construction of many trash containers can exacerbate the issue, as the container may flex or lift off the floor during attempts to remove the bag. To address this problem without increasing costs, a more effective and inexpensive trash container design is needed that can prevent vacuum formation and reduce friction, making it easier to remove full trash bags.

Accordingly, it is desirable to provide an easier-to-use trash can which offers a multitude of benefits, including improved hygiene, enhanced convenience, reduced odor, heightened safety, and potential environmental advantages. The presently disclosed technology seeks to effectively prevent the spread of germs and bacteria, saving time and effort for individuals with busy schedules or physical limitations. By reducing unpleasant odors and providing features such as easier access for those with disabilities, these trash cans can also enhance safety and create a more pleasant environment. Additionally, the presently disclosed technology can promote recycling and waste reduction, contributing to a more sustainable future. Such technology can enable people to significantly improve their daily lives and contribute to a healthier, more sustainable community.

### SUMMARY OF THE INVENTION

Embodiments of the disclosed technology are directed to devices, systems and/or apparatuses directed to a refuse receptacle specially adapted to facilitate the quick and effortless unloading of full trash bags and placement of new, empty trash bags therein. Specifically, the disclosed technology may have at least a receptacle body formed of one or more side wall portions. The body may have a bottom or a base and a top lid as well as a mechanism for toggling of the lid for purposes of placing refuse into the receptacle and/or a bag disposed therein. Furthermore, in each embodiment, the side walls have one or more doors hingedly affixed at at least one edge in order to facilitate the opening of the door or doors in order to access the interior region of the receptacle. In embodiments, the side walls may be entirely or partially formed by one or more doors. The door or doors are provided for ease of loading and unloading of waste bags or liners inside the receptacle.

In different embodiments, a vertical edge of a side wall or door may be equipped with a sophisticated latching or locking mechanism designed to securely affix the edge to an opposing edge, facilitating the opening and closing of side access to the interior region of the receptacle. This mechanism may incorporate a robust spring-loaded latch, a secure deadbolt, or a combination of these elements to ensure a reliable and tight seal, preventing leakage or unauthorized access. To toggle the latching or locking mechanism, a conveniently located button or lever may be integrated into the upper region of the receptacle, allowing for easy operation with a single hand. This user-friendly design ensures effortless access to the interior while maintaining a secure closure, even in challenging environments or under heavy use. The latching or locking mechanism may be further enhanced with additional features, such as a visual indicator to confirm the status of the latch, or a fail-safe mechanism to prevent accidental opening.

In one embodiment of the disclosed technology, a refuse container is provided. The refuse container may have a substantially cylindrical container with a contiguous side wall that is substantially cylindrically shaped. The side wall may terminate at a top end and a bottom end. The side wall has a substantially circular cross section. The refuse container may also have a lid hingedly affixed at the top end of the container, configured to selectively operate between an open position and a closed position. Further, a base may be affixed at the bottom end of the container. A first pedal disposed at the bottom end of the container, extending orthogonally from the base may be operable to selectively toggle the lid between the open position and the closed position. A door may be disposed on and may form a portion of the contiguous side wall. The door may be structured such that the door is configured to selectively operate between an open position and a closed position. The open position of the door facilitates access to an interior region of the container.

A second pedal may be disposed at the bottom of the container, extending orthogonally from the base and/or from the bottom end of the side walls. The second pedal may be operable to selectively toggle the door between the open position and the closed position. Two opposing members may also be disposed near the top end of the container, within an interior region thereof, substantially forming an arc shape of a circle with a lesser diameter than that of the substantially circular cross section of the sidewall. The two opposing members may be adapted to receive and securely hold a refuse bag.

In one embodiment, both the first pedal and the second pedal extend orthogonally from the bottom end of the container. In another embodiment, the refuse container further comprises a clip disposed on the door, corresponding to an affixing point disposed in the interior region of the container for releasably affixing the door in the closed position.

Additionally, the refuse container may include a knob extending from the door, operable to manually pull the door to the opened position. This knob can be releasably affixed to a magnetic catch disposed on a corresponding point of the interior region of the container.

Furthermore, the refuse container may have a lever disposed on the exterior of the door, operable to releasably attached to a catch mechanism disposed in the interior region of the container to selectively operate the door between the open position and the closed position.

In still another embodiment, the refuse container may include a second door symmetrically opposing the door, wherein the second door and the door are operable to open in a butterfly motion when the second pedal is pressed. The door and the second door may also be releasably affixed by magnets when the door and the second door are in the opened position.

In another embodiment of the disclosed technology, an alternative form of the refuse container is disclosed. The refuse container addresses the challenges associated with traditional trash cans. This container may have a substantially hollow side wall partially formed of one or more doors that can be hingedly opened radially outwards. A lid and a base are affixed to the top and bottom ends of the container, respectively. To facilitate hands-free operation, the base includes a first pedal for controlling the lid and a second pedal for operating the doors. The refuse container also incorporates a refuse bag holder located near the top end of the side wall, designed to securely hold a refuse bag inside the hollow portion of the container.

A mechanism is in place to maintain the doors in the closed position, ensuring a hygienic and odor-free environment. One particular embodiment of the refuse container features two equally sized, opposing doors disposed in the sidewall. These doors are configured to open horizontally in a butterfly position, providing easy access to the hollow portion of the container and the refuse bag holder. This design enhances convenience and efficiency while maintaining the overall structural integrity of the container. The dual-door mechanism, hands-free operation, and secure refuse bag holder, make it a practical and efficient means for waste disposal.

“Butterfly” operation of doors, as described in this specification, may be defined as a type of hinged door system that opens outward in a symmetrical, butterfly-like fashion. They are typically used in applications where a wide, unobstructed opening is required, such as in cabinets, closets, or vehicles. Butterfly doors are typically hinged at their top and bottom edges, allowing them to pivot outward in a symmetrical arc. The two doors are typically positioned opposite each other on the same plane, creating a symmetrical opening when both are opened. To assist in opening and closing the doors, spring mechanisms can be incorporated. These springs may be tension or torsion springs, and they provide the necessary force to open and close the doors smoothly. To keep the doors closed when desired, locking mechanisms may be used. These may include latches, catches, or magnetic closures.

When doors are opened in a butterfly configuration, they pivot outward in a symmetrical arc, creating a wide, unobstructed opening. The spring mechanisms assist in this process, providing the necessary force to open the doors. To close the doors, they are simply pushed together. The spring mechanisms help to guide the doors into their closed position and ensure a secure seal. Alternatively, release of a pedal may cause the doors to close automatically under force of a hinged spring. If a locking mechanism is present, it can be engaged to keep the doors securely closed. This is particularly useful in applications where the doors need to remain closed for safety or security reasons.

Such a door configuration provides a large, unobstructed opening, making them ideal for applications where access to a wide space is required, such as when a bulky, large refuse bag needs to be removed from its container. The symmetrical design of butterfly doors ensures a balanced and aesthetically pleasing appearance. These door mechanisms are easy to open and close, due to the possible use of spring mechanisms and a straight-forward design.

In another embodiment of the disclosed technology, a method is provided for operating a refuse container. The method is directed towards operating a cylindrical refuse container and involves a series of steps to ensure efficient and hygienic waste disposal. First, the side foot pedal is pressed to open a portion of the side wall, granting access to the interior region of the container. A refuse bag is then suspended onto an interior bag holder, ensuring it remains securely in place while the side wall is closed.

Next, the front foot pedal is pressed multiple times to open the lid and deposit refuse into the bag. This allows for convenient waste disposal without the need for manual handling of the bag. The frequency of pressing the front foot pedal can be adjusted to accommodate the amount of waste being deposited. After the desired amount of refuse has been deposited, the side foot pedal is pressed again to open the side wall. This allows the refuse bag to be easily pulled out of the container for disposal.

The streamlined process minimizes contact with the waste, promoting a more hygienic and efficient waste management system. The steps of the method may not involve this specific sequence of actions. The methods seek to effectively utilize the container's features, including the side wall opening mechanism, the lid, and the interior bag holder. This method enhances convenience, efficiency, and hygiene in waste disposal.

A better understanding of the disclosed technology will be obtained from the following brief description of drawings illustrating exemplary embodiments of the disclosed technology.

### BRIEF DESCRIPTION OF THE DRAWINGS

FIG. 1 shows a perspective view of a right side of an improved garbage pail in accordance with embodiments of the present invention.

FIG. 2 shows a rear perspective view of a left side of an improved garbage pail in accordance with embodiments of the present invention.

FIG. 3 shows a perspective view of a right side of an improved garbage pail in accordance with embodiments of the present invention.

FIG. 4 shows a rear perspective view of a right side of an improved garbage pail in accordance with embodiments of the present invention.

FIG. 5 shows a front perspective view of an improved garbage pail in its opened position in accordance with embodiments of the present invention.

FIG. 6 shows a rear perspective view of an improved garbage pail in its opened position in accordance with embodiments of the present invention.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

Generally, disclosed is a hinged front door trash bin which offers a unique and innovative approach to waste disposal. By incorporating a hinged door or doors on the front of the container, this design eliminates the need to lift the entire bin to remove full trash bags. This feature provides significant benefits, particularly for individuals with physical limitations or those who simply find the traditional lifting method cumbersome.

The following illustrative embodiments exemplify one or more embodiments, though they do not encompass all potential implementations. It is understood that the development of any actual embodiment involves numerous implementation-specific decisions to align with system-related and business-related constraints. These constraints can vary significantly between implementations, necessitating a tailored approach.

For example, system-related constraints might include compatibility with existing hardware and software, integration with other systems or networks, and adherence to industry standards or regulations. Business-related constraints might involve factors such as cost, performance, scalability, security, and user experience. Addressing these constraints requires careful consideration and may involve trade-offs between different objectives.

While the development process may be complex and time-consuming, it is considered routine for those skilled in the art with access to this disclosure. By leveraging their expertise and understanding of the underlying principles, engineers can effectively navigate the challenges and create functional and effective implementations.

Within this specification, references may be made to the spatial relationships between components and the spatial orientation of various aspects of these components as depicted in the accompanying drawings. However, it is essential to recognize that the devices, members, apparatuses, etc., described herein can be positioned in any desired orientation. Therefore, the use of terms to describe spatial relationships or orientations should be interpreted as relative descriptions, acknowledging that the device can be oriented in any direction. Generally, with respect to this specification and any disclosed embodiments of a garbage container, “top” or “upper” generally refers to the region of the container where a lid may be affixed. Moreover, “bottom” or “lower” generally refers to the base region of the container, where, for example, one or more foot pedals may be disposed. The term “substantially” may be defined as some relationship that is within a predefined tolerance outside of a complete overlap. That is, for example, if the pedal is located near the bottom portion of the container the pedal may be considered to be disposed “substantially” at or near the bottom of the container.

The primary components of the hinged front door trash bin include the container body, hinged front door, latching mechanism, one or more pedals, and/or a lid. Additional features may include odor control features, recycling compartments, antimicrobial coatings, waterproof design, and/or wheels. The container body is typically constructed from durable materials such as plastic, metal, or a combination of both. The hinged front door is attached to the container body and is equipped with a robust hinge mechanism that allows it to open and close smoothly.

A reliable latching mechanism may be incorporated to secure the front door in the closed position, while odor control features such as activated carbon filters or sealed designs can help to minimize unpleasant smells. In some embodiments, these hinged front door trash bins may also be equipped with multiple compartments to facilitate recycling and trash within the same container. This innovative design offers several functional advantages over traditional top-loading designs. By simply opening the front door, users can access and remove full trash bags without lifting the entire bin, reducing physical strain and making it more suitable for individuals with physical limitations.

The hinged front door design can also help to prevent the spread of germs and bacteria by minimizing the need to handle the exterior of the bin. Additionally, the sealed design and potential odor control features can help to reduce unpleasant odors, creating a more pleasant environment. When designing a hinged front door trash bin, several factors must be considered. The size and capacity of the bin should be appropriate for the intended user, taking into account factors such as household size, waste generation rate, and available space. The materials used for the container body and door should be durable, resistant to damage, and easy to clean.

The latching mechanism should be reliable, secure, and easy to operate, while odor control features should be effective and maintain their effectiveness over time. If recycling compartments are included, they should be designed to be easily accessible and clearly labeled.

The hinged front door of the trash bin seeks to provide a practical and innovative solution to the challenges associated with traditional trash disposal methods. By providing easier bag removal, reduced physical strain, improved hygiene, and enhanced odor control, this design can significantly improve the waste disposal experience for individuals of all ages and abilities. As technology continues to advance, it is likely that we will see even more innovative and user-friendly trash bin designs emerging in the future.

Referring now to the figures, devices, apparatuses /d/ systems are provided for a refuse receptacle specially adapted to facilitate the quick and effortless unloading of full trash bags and placement of new, empty trash bags therein. Specifically, the disclosed technology may have at least a receptacle body formed of one or more side wall portions. The body has a base and a top lid as well as a mechanism for toggling of the lid for purposes of placing refuse into the receptacle and/or a bag disposed therein. Furthermore, in each embodiment, the side walls have one or more doors hingedly affixed at at least one edge in order to facilitate the opening of the door or doors in order to access the interior region of the receptacle. In embodiments, the side walls may be entirely or partially formed by one or more doors. The door or doors are provided for ease of loading and unloading of waste bags or liners inside the receptacle. Although the terms “refuse”, “waste”, “trash”, and/or “garbage” may be used interchangeably with respect to the disclosed container, it should be noted that the disclosed container may be used for any waste and/or debris collecting tasks. Such waste collecting tasks may include, but are not limited to: household garbage, organic matter, recycling, construction debris, leaves, brush, industrial waste, and/or any other type of byproduct intended to be collected and stored in bags.

The apparatuses, systems, devices and/or methods described herein address one or more of the common problems associated with traditional trash cans. Specifically, the container is designed to include a door that effectively releases suction pressure within the trash can as the trash bag is removed. This door is located along the side of the trash can and opens selectively as needed, allowing the trash bag to tip out effortlessly. When not in use, the door is sealed shut, held securely in place by one or more retainers. The shape and design of the door may be such that, when in the closed position, the door seamlessly blends into the side walls of the container in order to provide a clean and aesthetically pleasing appearance.

Additionally, the disclosed technology is configured to facilitate easy cleaning by allowing for selective access to the interior region of the container. A holder ensures the weight of the trash bag is not entirely resting upon the base portion, ensuring that the bag can be removed without dragging its contents along the base of the pail. These innovative features, along with others discussed below and illustrated in the accompanying drawings, contribute to the improved functionality and user experience of the disclosed technology. A dual foot pedal mechanism may be provided for hands-free operation. The first foot pedal controls the lid, while the second foot pedal opens a front door on the pail for ease of bag removal and/or installation.

The structure and operation of the disclosed technology can be fully understood by examining the accompanying drawings in conjunction with the provided description. Several embodiments are presented herein, and it should be noted that various components, parts, and features of these embodiments can be combined or interchanged as needed, all within the scope of the present application.

Furthermore, the mixing and matching of features, elements, and functions between different embodiments is expressly contemplated. This means that one skilled in the art can appreciate from this disclosure that features, elements, or functions from one embodiment can be incorporated into another embodiment as appropriate, unless otherwise specified.

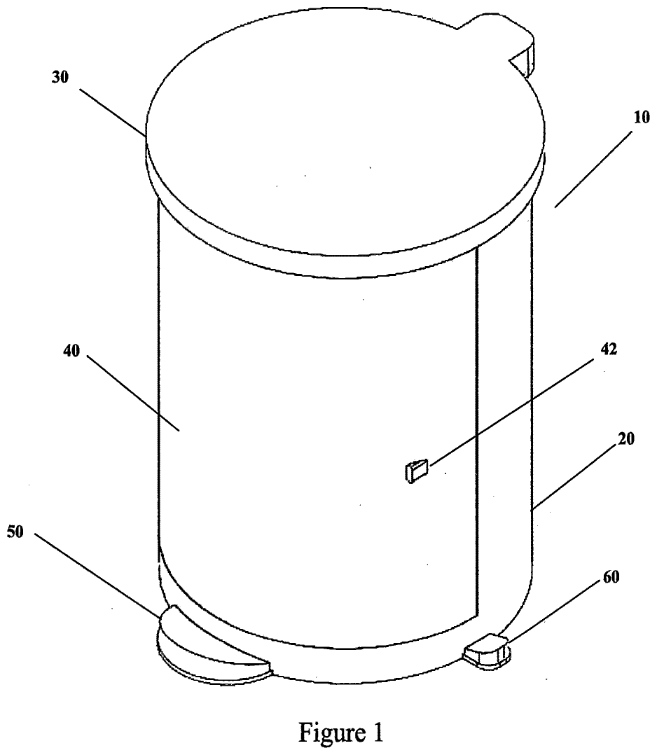

Referring now to FIG. 1, a perspective view is shown of a right side of an improved garbage pail in accordance with embodiments of the present invention. The depicted refuse container 10 is a cylindrical container designed for efficient and hygienic waste disposal. This innovative design incorporates a foot pedal mechanism 50, allowing for hands-free operation and promoting cleanliness. The pail's construction and features are tailored to meet the demands of various environments, from residential settings to commercial spaces.

It should be noted that, for purposes of this specification, the disclosed technology may interchangeably be referred to as “garbage pail 10”, “refuse container 10”, “trash pail 10”, “trash container 10”, “refuse pail 10”, and/or any combination of these words. All of these terms should collectively and generally have the same or a substantially similar definition. That is, the disclosed container may be used to collect any type of waste or debris. This may include recycling, organic waste, household trash, construction waste, leaves & brush, and/or any other material sought to be collected into a single container or bag.

The body 20 of the refuse container 10 may be constructed of a durable and corrosion-resistant material, such as, for example, high-density polyethylene (HDPE) or stainless steel. In this specification, the term “body 20” and “side wall 20” may be generally used to describe the substantially vertical portions of the container 10 which extend between a lid 30 and a bottom end (where the pedals 50, 60 may be disposed). These materials ensure the pail's longevity and ability to withstand the weight of waste and the rigors of daily use.

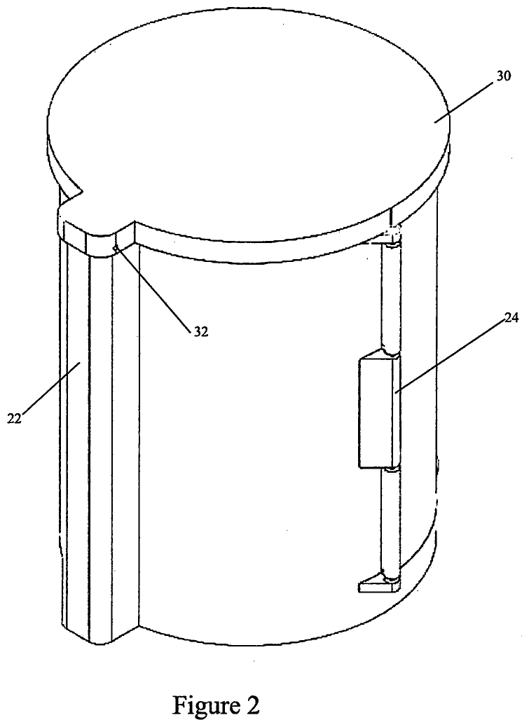

FIG. 2 shows a rear perspective view of a left side of an improved garbage pail in accordance with embodiments of the present invention. The circular lid 30, hinged along one side, provides a secure seal to prevent odors, pests, and liquids from escaping. The top hinge 32 is designed to allow for smooth and effortless opening and closing of the lid 30, even when the pail 10 is full. The innovative foot pedal mechanism 50 is a key feature of this garbage pail. It consists of a lever-like structure 50 attached to the base of the pail. When pressed, the foot pedal 50 activates a spring, lever and/or other mechanical component disposed within the backbone 22 of the refuse container 10, causing the lid 30 to pivot upward and open. This hands-free operation is particularly beneficial in environments where maintaining hygiene is crucial, such as kitchens, bathrooms, and public spaces.

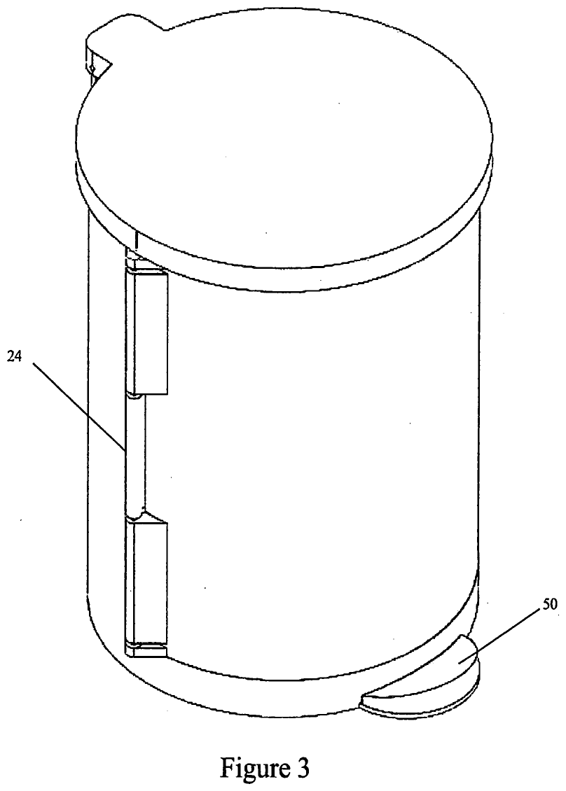

Another hinge 24 may also be incorporated into the container 10. This hinge 24 may be operable to enable the opening and closing of the door 40 as will be described in further detail with respect to FIG. 3 through FIG. 6.

In further embodiments, a spring, either a tension spring or a torsion spring, is connected to the lid 30 and foot pedal 50. This spring provides the necessary force to close the lid 30 after it has been opened. When the foot pedal 50 is released, the spring pulls the lid 30 back down, ensuring that the refuse container 10 remains closed and secure. Alternatively, a spring may provide torsion and resistance in the opposite direction. That is, the spring may act to hold the lid 30 in the shut position (as depicted in FIGS. 1 and 2). As such, when the pedal 50 is pressed, the spring deforms, thereby creating potential energy sufficient to self-close the lid 30 when the pedal is released. In addition to these features, a soft-close mechanism may be incorporated into the hinge 32 in order to prevent abrupt closing in order to avoid injuries and damages. This is especially important with respect to protecting children's extremities.

FIG. 3 shows a perspective view of a right side of an improved garbage pail in accordance with embodiments of the present invention. As depicted, the refuse container 10 may have a substantially cylindrical container with a contiguous side wall 20 that is substantially cylindrically shaped. The side wall 20 may terminate at a top end and an opposing bottom end. In this embodiment, the side wall 20 has a substantially circular cross section. The refuse container 10 may also have a lid 30 hingedly affixed at the top end of the container, configured to selectively operate between an open position and a closed position. Further, a base may be affixed at the bottom end of the container. A first pedal 50 disposed at the bottom end of the container, extending orthogonally from the base or bottom may be operable to selectively toggle the lid 30 between the open position and the closed position.

A door 40 may be disposed on and forming a portion of the contiguous side wall 20. The door 40 may be structured such that the door is configured to selectively operate between an open position and a closed position. The open position of the door 40 facilitates access to an interior region of the container 10. A hinge 24 rotationally affixes the door 40 to sit flush within the side wall 20. The hinge 24 may contain the aforementioned spring for exerting radial tension or compression on the door 40.

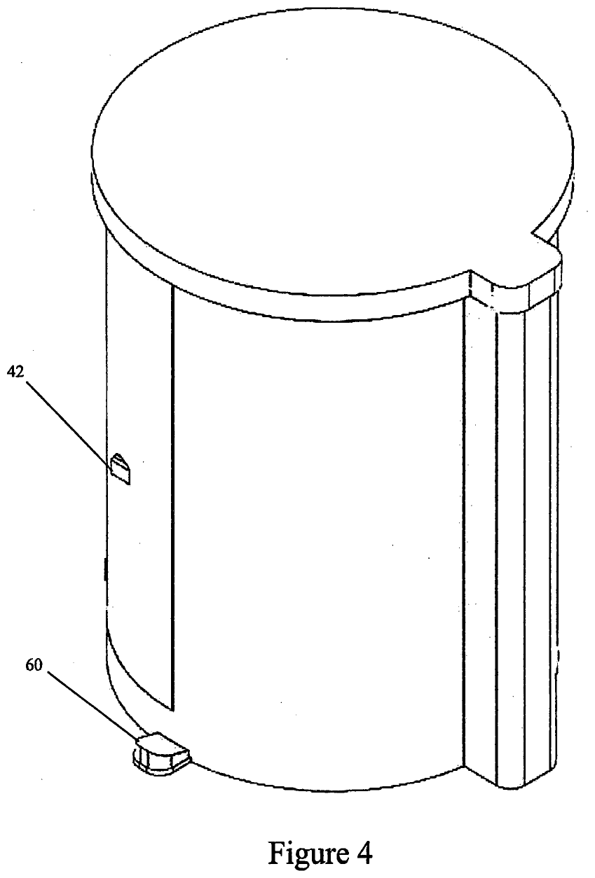

FIG. 4 shows a rear perspective view of a right side of an improved garbage pail in accordance with embodiments of the present invention. The refuse container 10 may include a knob extending from the door, operable to manually pull the door to the opened position. This knob can be releasably affixed to a magnetic catch disposed on a corresponding point of the interior region of the container 10.

Alternatively, as depicted in FIG. 4, the refuse container 10 may have a lever 42 disposed on the exterior of the door, operable to releasably attach to a catch mechanism disposed in the interior region of the container to selectively operate the door between the open position and the closed position. The catch mechanism may be, for example, but not limited to, a magnetic catch, a frictional wedge, a clasp, and/or any other type of releasable locking mechanism known in the art.

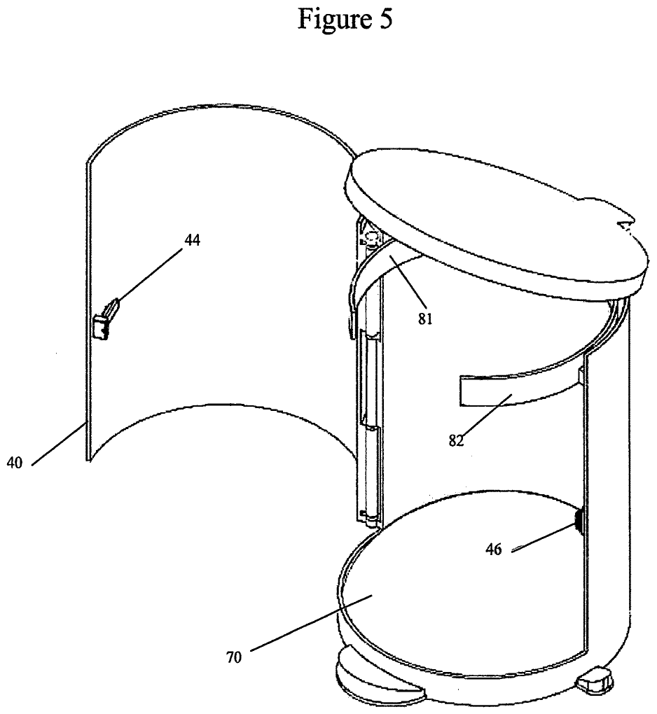

FIG. 5 shows a front perspective view of an improved garbage pail in its opened position in accordance with embodiments of the present invention. As mentioned, the door 40 may be disposed on and may form a portion of the contiguous side wall 20. The door 40 may be structured such that the door is configured to selectively operate between an open position and a closed position. The open position of the door 40 facilitates access to an interior region of the container. The open position is depicted in FIG. 5. When the door 40 is opened, it pivots outward in a symmetrical arc, creating a wide, unobstructed opening. A spring mechanism in the door hinge 24 may assist in this process, providing the necessary force to open the door 40. Alternatively, a spring mechanism may assist in closing the door 40 such that when the second pedal 60 is released, the door 40 automatically closes.

The second pedal 60, as shown, may be disposed at the bottom of the container 10, extending orthogonally from the base. The second pedal 60 may be operable to selectively toggle the door 40 between the open position and the closed position. Two opposing members 81, 82 may also be disposed near the top end of the container 10. These members 81, 82 may substantially form an arc shape of a circle with a lesser diameter than that of the substantially circular cross section of the sidewall 20. The two opposing members 81, 82 may be adapted to receive and securely hold a refuse bag (not shown). In an alternative embodiment, the two opposing members 81, 82 may be connected such that they form a singular large arc of a circle.

The interior portion of the door lever 44 is disposed along the interior edge of the door 40. This door lever 44 corresponds to and mates with the catch 46 disposed along the interior region of the container on an interior sidewall thereof. An interior base 70 is provided inside the container 10 in order to support the weight of any bag of debris that may be used inside the container. In further embodiments, the interior base 70 may be removable for cleaning. Further, the interior base 70 may have an antimicrobial coating and/or a substantially friction-less coating so as to not cause ripping of a refuse bag as it is being pulled out of the container 10.

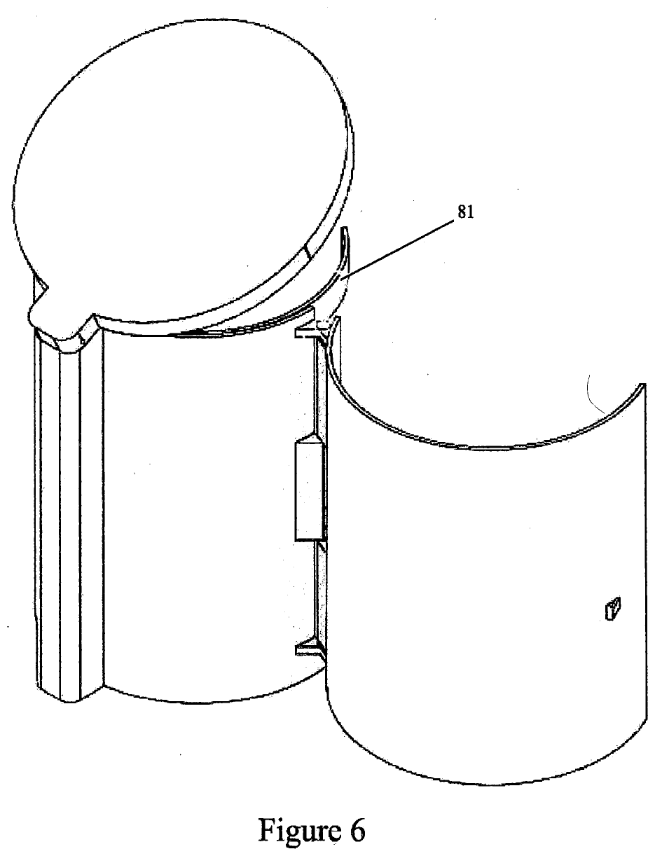

FIG. 6 shows a rear perspective view of an improved garbage pail in its opened position in accordance with embodiments of the present invention. Each of the one or more of the components of the disclosed container may be composed of one or more of the following materials: wood, plastic, aluminum, stainless steel, any type of metal, polymer, thermoplastic, polymer, epoxy-resin, rubber, elastomer, polyethylene terephthalate (PET), amorphous polyethylene terephthalate (APET), oriented polyethylene terephthalate (OPET), metalized polyethylene terephthalate (MET-PET), polyethylene (PE), low density polyethylene (LDPE), linear low density polyethylene (LLDPE), metalocene linear low density polyethylene (mLLDPE), high density polyethylene (HDPE), metalocene polyethylene (mPE), ethylene vinyl acetate (EVA), polypropylene (PP), metalized oriented polypropylene (mOPP), polystyrene (PS), high impact polystyrene (HIPS), foil, ethylene vinyl alcohol (EVOH), polyamide, Nylon, polyvinyl chloride (PVC) and/or any other material known in the art of debris collection and/or disposal. In further embodiments of the disclosed technology, different parts of the container may be formed of different materials based on the particular application. For example, the hinge may be formed of stainless steel while the body (and/or side walls) may be formed of a hard, high density polymer.

It should be noted for purposes of this specification that, while referred to separately, the side wall(s) 20 and the door(s) 40 may, in some embodiments, be one in the same. That is, under certain embodiments, these components may overlap in their functionality. For example, in one embodiment, a distinct door 40 may be cut out of the side walls 20. However, in another embodiment, the side walls 20 may simply open up entirely, thereby acting as a door for all intents and purposes.

Use of the container 10 may be carried out by the user executing a simple progression of steps. First, the refuse container 10 is provided to the user. The method of use may involve a series of steps to ensure efficient and hygienic waste disposal. First, the side foot pedal 60 is pressed to open a portion of the side wall 20 (or door 40). This operation grants the user access to the interior region of the container 10. A refuse bag is then suspended onto an interior bag holder 81, 82. The holder 81, 82 ensures that the bag remains securely in place while the door 40 of the side wall 20 is closed.

Next, the front foot pedal 50 is pressed one or more times to open the lid 30 as desired in order to deposit refuse into the bag. This allows for convenient waste disposal without the need for manual handling of the bag or hand opening of the lid. The frequency of pressing the front foot pedal 50 may be in accordance with the amount of waste being deposited. After the bag is sufficiently full, the side foot pedal 60 is pressed again to open the door 40 of the side wall 20. This allows the refuse bag to be easily pulled out of the container 10 for disposal.

The streamlined process minimizes contact with the waste, promoting a more hygienic and efficient waste management system. The steps of the method may not involve this specific sequence of actions. The method or methods disclosed seek to effectively utilize the container's features, including the side wall opening mechanism 40, the lid 30, and the interior bag holder 81, 82. This method enhances convenience, efficiency, and hygiene in waste disposal.

In another embodiment of the disclosed technology, access to the interior region of the container may take on a different form entirely. That is, two symmetrically opposing doors may form a portion of the side wall such that when the second lever is pressed, both doors swing outwards in a “butterfly” type motion. In this embodiment, two equally sized, opposing doors may be disposed in the sidewall. These doors are configured to open horizontally in a butterfly position, providing easy access to the hollow portion of the container and the refuse bag holder. This design enhances convenience and efficiency while maintaining the overall structural integrity of the container. The dual-door mechanism, hands-free operation, and secure refuse bag holder, make it a practical and efficient means for waste disposal.

“Butterfly” operation of doors, as described in this specification and in the claims, may be defined as a type of hinged door system that open outward in a symmetrical, butterfly-like fashion. The doors in this embodiment may be hinged at their top and bottom edges, allowing them to pivot outward in a symmetrical arc. The two doors are positioned opposite each other, creating a symmetrical opening when both are opened and forming a contiguous side wall when closed. To assist in opening and closing the doors, spring mechanisms can be incorporated. These springs may be tension or torsion springs, and they may provide the necessary force to open and/or close the doors smoothly. To keep the doors closed when desired, locking mechanisms may be used. These may include latches, catches, or magnetic closures. For example, magnets may be embedded along the opposing edges of the doors which abut one another when the doors are closed.

When doors are opened in a butterfly configuration, they pivot outward in a symmetrical arc, creating a wide, unobstructed opening. The spring mechanisms assist in this process, providing the necessary force to open the doors. To close the doors, they are simply pushed together. The spring mechanisms help to guide the doors into their closed position and ensure a secure seal. Alternatively, release of a pedal may cause the doors to close automatically under force of a hinged spring. If a locking mechanism is present, it can be engaged to keep the doors securely closed. This is particularly useful in applications where the doors need to remain closed for safety or security reasons.

Such a door configuration provides a large, unobstructed opening, making them ideal for applications where access to a wide space is required, such as when a bulky, large refuse bag needs to be removed from its container. The symmetrical design of butterfly doors ensures a balanced and aesthetically pleasing appearance. These door mechanisms are easy to open and close, due to the possible use of spring mechanisms and a straight-forward design.

One skilled in the art will recognize that an implementation of an actual apparatus or method may contain other components as well. While it is obvious that modification or proper change and combination can be made to the present lid according to the present invention by those skilled in the art, however, without departing from the contents, spirit and scope of the invention, any variations that are intended to achieve the techniques disclosed in the present invention should be within the scope of this invention. Specifically, it should be pointed out that all similar substitutions and modifications are obvious to those skilled in the art, and they are deemed to be within the scope and content of the present invention.

The current application offers a substantial improvement over existing trash can technologies, providing several key advantages. One such advantage is Suction-free bag or liner removal. The novel design eliminates the frustrating suction forces commonly encountered when removing garbage bags from containers, making the process smoother, more efficient, and less messy. Another advantage is the convenient access door. The strategically placed door allows for easy removal of the trash bag by simply pulling it laterally out of the container, reducing the need for manual handling and minimizing the risk of spills or messes. This feature is particularly beneficial in situations where the refuse bag may be heavy or difficult to lift.

Another advantage of the disclosed technology is its enhanced cleaning capability. The open-door design allows for thorough cleaning of the container's interior in between bag changes, ensuring a hygienic and sanitary environment. This feature is essential for maintaining a clean and odor-free trash can, particularly in areas with high levels of foot traffic or in commercial settings. Still another advantage is the internal bag holder which holds the weight of the trash bag separately from the base, preventing any leakage or contamination of the interior and facilitating easy cleaning. This feature helps to keep the pail clean and prevent the spread of bacteria or odors.

The specific embodiments described above are illustrative and not exhaustive. The application can be modified and practiced in various equivalent ways by those skilled in the art who have a thorough understanding of the underlying principles. It is clear that the modifications and alterations to the disclosed embodiments are within the scope and spirit of the application. The protection sought herein is as outlined in the accompanying description.

The application represents a significant advancement in the field of garbage pail technology, offering numerous benefits to users. While the current examples showcase a limited number of forms, the application is not restricted to these specific configurations and can be adapted to various changes and modifications without deviating from its core principles.

It is to be understood that the foregoing detailed description and accompanying drawings relate to a preferred illustrative embodiment of the invention. However, various changes and modifications may be made without departing from the spirit and scope of the invention.

Accordingly, the present invention is not limited to the specific arrangements as shown in the drawings and described in detail herein above. The exemplary materials, constructions and illustrations included in the preferred embodiment and this patent application should therefore not be construed to limit the scope of the present invention, which is defined by the appended claims.

While the disclosed invention has been taught with specific reference to the above embodiments, a person having ordinary skill in the art will recognize that changes may be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, apparatuses, and devices described hereinabove are also contemplated and within the scope of the invention.

1. A refuse container, the refuse container comprising:
a substantially cylindrical container, the container having a contiguous side wall that is substantially cylindrically shaped, terminating at a top end and a bottom end, the side wall having a substantially circular cross section;
a lid hingedly affixed at the top end of the container, the lid configured to selectively operate between an open position and a closed position;
a base affixed at the bottom end of the container;
a first pedal disposed at the bottom end of the container, extending orthagonally from the base, the first pedal operable to selectively toggle the lid between the open position and the closed position; and
a door disposed on and forming a portion of the contiguous side wall such that the door is configured to selectively operate between an open position and a closed position, wherein the open position of the door facilitates access to an interior region of the container;
a second pedal disposed at the bottom of the container, extending orthagonally from the base, the second pedal operable to selectively toggle the door between the open position and the closed position; and
two opposing members disposed near the top end of the container, wherein the two opposing members substantially form an arc shape of a circle with a lesser diameter than that of the substantially circular cross section of the sidewall, further wherein the two opposing members are adapted to receive and securely hold a refuse bag.

2. The refuse container of claim 1, wherein the first pedal and the second pedal each extend orthagonally from the bottom end of the container.

3. The refuse container of claim 1, further comprising a clip disposed on the door, wherein the clip corresponds to an affixing point disposed in the interior region of the container for releasably affixing the door in the closed position.

4. The refuse container of claim 1, further comprising a knob extending from the door, the knob operable to manually pull the door to the opened position.

5. The refuse container of claim 4, wherein the knob is releasably affixed to a magnetic catch disposed on a corresponding point of the interior region of the container.

6. The refuse container of claim 1, further comprising a lever disposed on the exterior of the door, wherein the lever is operable releasably attached to a catch mechanism disposed in the interior region of the container to selectively operate the door between the open position and the closed position.

7. The refuse container of claim 1, further comprising a second door symmetrically opposing the door, wherein the second door and the door are operable to open in a butterfly motion when the second pedal is pressed.

8. The refuse container of claim 7, wherein the door and the second door are releasably affixed by magnets when the door and the second door are in the opened position.

9. A refuse container comprising:
a substantially hollow contiguous side wall flanked at a top end by a lid and at a bottom end by a base, wherein the contiguous side wall is partially formed of one or more doors, the one or more doors being operable to hingedly open radially outwards from the side wall;
wherein the base has a first pedal and a second pedal extending orthagonally therefrom, wherein the first pedal is configured to selectively operate the lid between an open position and a closed position, further wherein the second pedal is configured to selectively operate the one or more doors between an open position and a closed position; and
a refuse bag holder disposed near a top end of the side wall, disposed inside the hollow portion of the side wall, wherein the refuse bag holder operates to secure a refuse bag inside the side wall; and
a mechanism for maintaining the one or more doors in the closed position.

10. The refuse container of claim 9, wherein the two equally sized, opposing doors are disposed in the sidewall, further wherein the doors are operable to be opened horizontally in a butterfly position to facilitate access to the hollow portion of the refuse container and the bag holder.

11. A method of operating a refuse container, comprising:
pressing a side foot pedal of a substantially cylindrical refuse container having a contiguous cylindrical side wall, a lid affixed atop the sidewall and a base affixed at the bottom of the side wall to form a substantially hollow enclosed interior region of the refuse container, wherein pressing of the side foot pedal causes a portion of the side wall to open outwardly to grant access to the interior region;
suspending a refuse bag onto an interior bag holder disposed within the interior region;
releasing the side foot pedal to facilitate the closing of the side wall;
pressing a front foot pedal one or more times to open the lid, wherein the opening of the lid grants access to an interior of the refuse bag, further wherein refuse is depositable into the refuse bag each time the front foot pedal is pressed;
pressing the side foot pedal a second time to open the portion of the side wall; and
pulling the refuse bag out of the interior region of the container for disposal.
